(19) United States
(12) Patent Application Publication
(10) Pub. No.: US 2020/0274438 A1
(43) Pub. Date: Aug. 27, 2020

(54) Leakage Energy Steering for Flyback Converters

(71) Applicant: Apple Inc., Cupertino, CA (US)

(72) Inventors: Bogdan T. Bucheru, Austin, TX (US); Poornima Mazumdar, Austin, TX (US); Marco A. Davila, JR., Spicewood, TX (US)

(21) Appl. No.: 16/445,421

(22) Filed: Jun. 19, 2019

Related U.S. Application Data
(60) Provisional application No. 62/811,324, filed on Feb. 27, 2019.

(51) Int. Cl. H02M 1/34; H02M 3/335

(52) U.S. Cl. CPC H02M 1/34; H02M 3/33569

(57) ABSTRACT

A leakage energy steering circuit for a flyback converter can include a leakage energy steering capacitor and a leakage energy steering diode configured to be coupled between a first output terminal and a first secondary winding terminal of a flyback converter. The leakage energy steering circuit can further include a reset circuit having an impedance element and a diode configured to be coupled between a junction of the leakage energy steering capacitor and the leakage energy steering diode and a junction of a second secondary winding terminal and a second output terminal of the flyback converter. The impedance element may be a resistor or an inductor.

### BACKGROUND

Switching power supplies (power converters) generate noise during operation because of variable magnetic and electric fields inherent in their operation. In isolated converters, an isolation transformer is used to provide electrical isolation and to process/store/convert the power between a primary side and a secondary side. Universal AC/DC converters, also known as adapters or chargers, may be designed to deliver a power level from few watts to hundreds of watts. Transformer design for a device will vary with power rating and construction. Because the transformer may be the main noise source during operation, transformer design requires careful consideration and balancing of several factors including, without limitation, nominal power rating, peak power rating, power loss/efficiency, thermal limitations (heat dissipation and cooling), volume and geometry, safety isolation, and noise. Optimizing these parameters is a design task that may result in contradictory requirements requiring trade-offs for optimal results in each particular case.

One commonly used isolated converter topology is the flyback topology, which is part of the single-ended family of topologies. The simplicity and flexibility of the flyback converter, including a wide input/output voltage range, makes it a common choice for design of AC/DC power converters in the 0-100 W range. An exemplary flyback converter 100 is illustrated in FIG. 1. Flyback converter 100 uses the transformer TX, more precisely coupled inductors Lp and Ls, to isolate the primary side electrical power (Vin) and convert it to a secondary side that delivers output power (Vout) to the load. Obtaining highly efficient power transfer between the primary winding Lp and the secondary winding Ls requires high magnetic coupling between the windings. (Ideal coupling may be considered as Cpl=1, or 100%.) However, numerous considerations can result in a less than ideal coupling between the primary and secondary windings.

For example, in some embodiments, one or more low power auxiliary bias windings (not shown) may be included to provide bias voltages and controller power for the converter. Auxiliary windings may have relatively poor coupling to the primary winding and may also interfere with the primary-secondary coupling. In other embodiments, electromagnetic noise considerations may result in transformer designs that reduce the parasitic capacitance Cps between primary and secondary windings Lp and Ls. However, this may also reduce the magnetic coupling between windings.

Overall the non-ideal coupling between primary and secondary power windings Lp and Ls of transformer TX may be reflected into a leakage inductance Llk. Leakage inductance Llk stores and steals leakage energy (LkE), i.e., energy that is taken from the input power source but is not delivered to the output. The result can be increased power losses (i.e., decreased efficiency). Additionally, dissipation of this leakage energy can be both an extra noise source and a source of higher voltage stress on the various converter components, caused for example by high frequency ringing across transformer windings.

Thus, there is a need for converter arrangements that mitigate one or more of the effects described above.

### SUMMARY

A flyback converter can include a primary side having a primary winding configured to be coupled to input voltage terminals by a primary switching device. The flyback converter can further include a secondary side having a secondary winding magnetically coupled to the primary winding and configured to be coupled to output voltage terminals by a rectifying device. The rectifying device may be a diode, a synchronous rectifier, or other suitable rectification circuit. The primary switching device may be operated alternately to store energy in the primary winding when closed and cause the stored energy to be transferred to the output when opened. The flyback converter may further include a leakage energy steering circuit coupled to the secondary winding. The leakage energy steering circuit may be operable to facilitate transfer of leakage energy from the primary side to the secondary side. The flyback may further include an active or a passive clamp circuit on the primary side.

The leakage energy steering circuit can include a steering circuit and, optionally, a reset circuit. The steering circuit can a leakage energy steering capacitor and a leakage energy steering diode coupled to the secondary winding. The leakage energy steering capacitor and the leakage energy steering diode may be coupled across the rectifying device. The reset circuit can include an impedance element and a diode coupling the leakage energy steering circuit to an output voltage terminal. The impedance element may be an inductor or a resistor. As an alternative to the reset circuit, the leakage energy steering circuit can include a resistor in parallel with the leakage energy steering diode.

A leakage energy steering circuit for a flyback converter can include a leakage energy steering capacitor and a leakage energy steering diode configured to be coupled between a first output terminal and a first secondary winding terminal of a flyback converter. The leakage energy steering circuit can further include a reset circuit having an impedance element and a diode configured to be coupled between a junction of the leakage energy steering capacitor and the leakage energy steering diode and a junction of a second secondary winding terminal and a second output terminal of the flyback converter. The impedance element may be a resistor or an inductor. The leakage energy steering circuit can also include a resistor in parallel with the leakage energy steering diode.

### BRIEF DESCRIPTION OF THE DRAWINGS

FIG. 1 depicts a schematic diagram of a flyback converter.

FIG. 2 depicts a schematic diagram of a flyback converter with a leakage energy steering circuit.

FIGS. 3A-3E depict switching stages of a flyback converter with a leakage energy steering circuit.

FIG. 4 depicts pertinent voltage and current waveforms of a conventional flyback converter without with a leakage energy steering circuit and a flyback converter including a leakage energy steering circuit.

FIGS. 5A-5C depict a flyback converter with an alternative leakage energy steering circuit and associated switching stages.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth in order to provide a thorough understanding of the implementations described herein. In other instances, methods, procedures and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

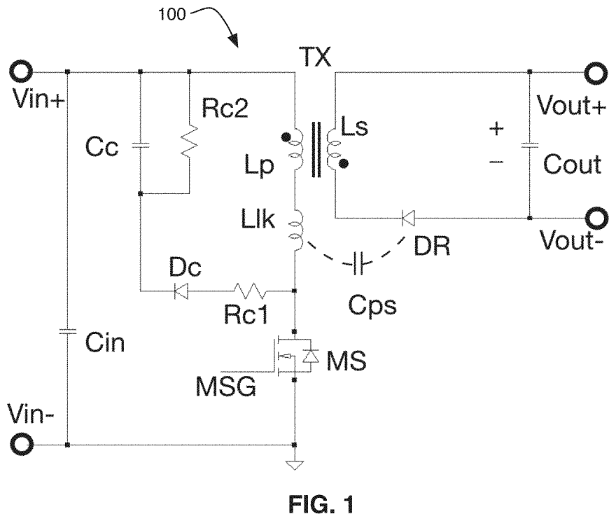

With further reference to FIG. 1, flyback converter 100 includes a primary side having an input filter Cin, a transformer TX (composed of primary winding Lp and secondary winding Ls) connected across input power rail Vin+/Vin− through a Main Switch MS (e.g., MOSFET) in primary side. Flyback converter 100 includes a rectifying diode DR on the secondary side. It will be appreciated that, in some embodiments, rectifying diode DR may be replaced by a synchronous rectifier device for improved efficiency through reduced forward conduction losses. Operation of the circuits described herein are substantially the same in either case. The output current is filtered by the output capacitor Cout, with the output voltage Vout appearing there across. Primary switch MS may be controlled through its gate signal MSG by a PWM controller (not shown). The parasitic capacitance between the primary and secondary windings is represented by capacitor Cps, and the leakage inductance by inductor Llk. FIG. 1 also shows passive clamp circuitry (Cc, Rc2, Dc, and Rc1) discussed in further detail below.

Flyback converter 100 may be operated in a continuous conduction mode (CCM), a discontinuous conduction mode (DCM), or a critical conduction mode also known as a quasi-resonant or QR mode. In the continuous conduction mode, main switch MS is operated such that there is always a positive current flowing through primary winding Lp. CCM mode may not be preferred for some implementations (e.g., high voltage operation) because of the difficulty of balancing the switching losses with the common mode noise caused by large, fast voltage swings (i.e., high dV/dt) across the windings. DCM operation can reduce switching losses as compared to CCM, and DCM flyback is often used for low power AC/DC adapters. One potential drawback of DCM operation can be reduced efficiency, particularly in high power applications (because of higher conduction losses) and high frequency applications (because of high switching losses). The QR mode of operation can offer a soft transition (i.e., lower dV/dt) for primary winding Lp and also a lower voltage across the main switch MS that can facilitate zero voltage switching (ZVS) of the main switch. However, QR mode operation necessitates a variable switching frequency across the input voltage range and across the output load range. Because the switching frequency increases when the load decreases, light load efficiency may be unacceptably inefficient due to increased switching losses.

As a result of the foregoing considerations, a combination of DCM and QR flyback modes with multiple valley switching (in fact a DCM with soft-switching) can be a preferred solution for many AC/DC adapter applications. In many cases, this operating mode provides a good trade-off between efficiency, noise, and light load performance. However, high voltage operation may still be problematic due at least in part to increased noise and partial soft-switching rather than true ZVS. These issues may be addressed by the active clamp flyback (ACFB) disclosed in U.S. Pat. No. 5,057,986. The ACFB converter requires a high voltage auxiliary switch and a capacitor to form a voltage clamp across the primary winding. (This is as opposed to the passive clamp illustrated in FIG. 1.) The ACFB arrangement allows the leakage energy LkE of the primary winding to be stored in and then recovered from the clamp capacitor. Depending of the capacitor choice, the magnetic energy of the transformer may be partially stored in the clamp capacitor before it (the magnetic energy) is delivered to the secondary side. With suitable design choices, some of the energy from the clamp can be used to achieve ZVS for the next switching cycle, helping to reduce common mode noise and improve efficiency. However, active clamp arrangements may disadvantageously complicate the overall converter design (particularly with respect to the driver circuitry for the clamp switch). Furthermore, the clamp cap energy storage function may significantly affect stability of the system, complicating the feedback loop of the control and limiting the transient response of the converter. Additionally, operation of the ACFB circuit is optimized for QR mode, potentially resulting in performance difficulties under light load conditions.

Although the ACFB converter can reuse the leakage energy LkE by storing it in the clamp cap and then resending to secondary and/or primary side, the side effects of the solution are increased complexity and cost. Thus, it would be desirable to find alternative solutions to mitigating the effects of the leakage inductance Llk and associated leakage energy Llk. However, even the ACFB implementation may benefit from controlling/reducing LkE.

One fundamental aspect of leakage inductance/leakage energy is that it manifests itself only during a “forward action,” of the converter. In other words, the primary winding Lp and secondary winding Ls have to be linked, i.e., linked currents flowing at the same time in the respective windings. In a flyback converter (for example converter 100), transformer TX is in fact a coupled inductor, with the primary and secondary windings Lp and Ls carrying current in an alternating fashion. More specifically, primary winding Lp is conducting during the energizing period (i.e., the on time of main switch MS). Secondary winding is conducting during the reset period (i.e., the off time of main switch MS). The only short intervals during which the two windings are simultaneously conducting are the transitions between the two periods (for CCM operation) or only at one transition (for DCM operation), when the energy has to switch from one winding to the other.

Thus, while the leakage energy LkE is schematically ascribed to a leakage inductance Llk, in reality there is no physical inductance present from the transformer TX. Typical presentations show Llk as an inductor in series with primary winding Lp, or secondary winding LS, or split between the two windings. FIG. 1 shows the typical schematic of a flyback converter 100, including primary side passive clamp circuitry (Cc, Dc, Rc1 and Rc2). This primary side passive clamp circuitry may be designed to limit the voltage spikes associated with the leakage energy. However, this solution is dissipative, resulting in power loss Lke=Llk*Ipk².

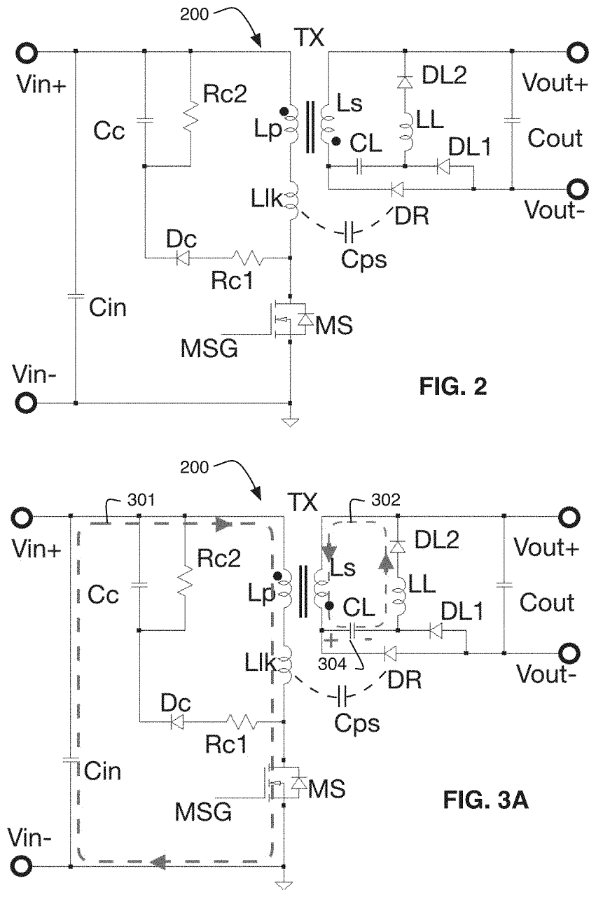

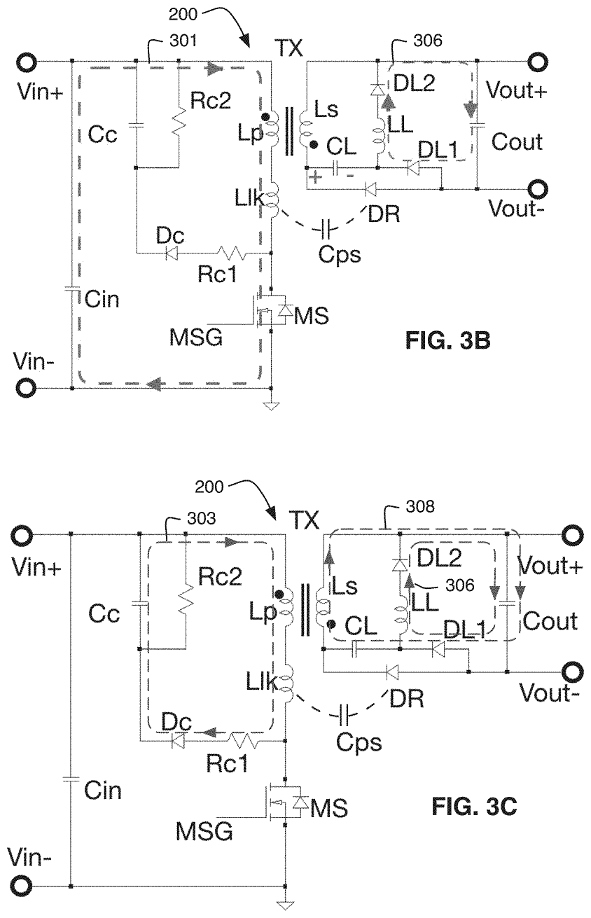

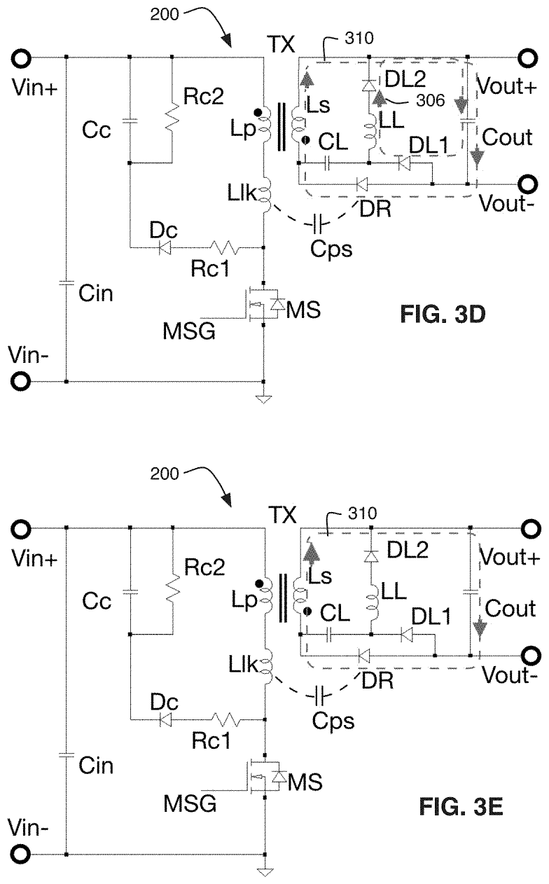

FIG. 2 illustrates a schematic of flyback converter 200 incorporating one embodiment of a leakage energy steering circuit. The leakage energy steering circuit includes capacitor CL and diode DL1. This leakage energy steering circuit is augmented by a resonant reset circuit comprising inductor LL and diode DL2. In other embodiments, inductor LL may be replaced with a resistor (not shown). The circuit will still be resonant due to the interaction of secondary winding Ls and capacitor CL, but some of the energy steered by the circuitry will be dissipated by the resistor. Thus, the inductor embodiment described herein may have higher operating efficiency, although the operations describe herein merely require an impedance element (such as a resistor or inductor). FIGS. 3A-3E illustrate the switching sequence for operating the circuit.

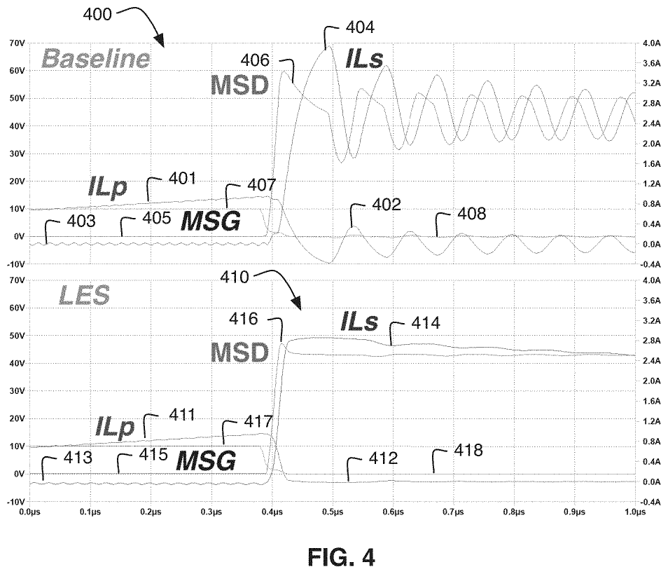

FIG. 3A illustrates the beginning of the switching cycle. Main switch MS is turned on, and transformer TX begins to energize as primary current 301 flows through primary winding Lp from the input. At the same time, a voltage 304 is induced across secondary winding Ls. Induced voltage 304 begins charging leakage energy steering capacitor 304 and causes a secondary current 302 that flows through leakage energy steering capacitor CL, resonant reset inductor LL, and reset diode DL2. As a result, leakage energy steering capacitor CL charges in a resonant mode (the resonance being due to the LC circuit formed by Ls, CL, and LL) until the voltage across CL is equal to the induced voltage 304. The primary and secondary current waveforms are illustrated and discussed further below with respect to FIG. 4.

FIG. 3B illustrates the second stage of the switching operation. In this second stage, main switch MS remains turned on. Primary current 301 continues to flow, which continues to store energy in transformer TX. Leakage energy steering capacitor CL has fully charged to induced voltage 304. As a result, current no longer flows through leakage energy steering capacitor CL. However, the current flowing through resonant reset inductor LL continues to flow. As a result, leakage energy steering diode DL1 becomes forward biased, and secondary current 306 begins to flow. Secondary current 306 flows through resonant reset inductor LL, resonant reset diode DL2 output capacitor Cout (and/or through the load connected at Vout), and leakage energy steering diode DL1.

FIG. 3C illustrates the third switching stage. In this stage, transformer TX is fully energized, so main switch MS is turned off, which stops the storing of energy in transformer TX. Primary winding Lp is changing polarity, driven mainly by the leakage energy Lke. On the secondary side, leakage energy steering diode DL1 is turning on due to charged leakage energy steering capacitor CL holding the voltage across secondary winding Ls. In the absence of leakage energy steering capacitor CL, the voltage across secondary winding Ls would otherwise tend to reverse polarity because of the polarity swap of primary winding Lp. As a result of diode DL1 turning on, secondary current 308 begins to flow to the output. This is the leakage energy steering effect, as leakage energy is transferred to the secondary side. Additionally, some of the leakage energy is circulated through the primary clamp circuitry (Rc1, Dc, Cc, and Rc2) by current 303 as shown. Additionally, resonant reset inductor LL continues to reset, also delivering current 306 to the output. It will be appreciated that both the leakage energy steering capacitor CL and the resonant reset inductor LL discharge into the output, which improves the overall operating efficiency of the circuit.

FIG. 3D illustrates the next switching stage, when the leakage energy is depleted. Transformer TX has reset. As a result, no current is flowing on the primary side. On the secondary side, leakage energy steering capacitor CL has completely discharged. Secondary winding Ls has finished its transition, and rectifier diode DR has turned on. As a result, full secondary current 310 flows to the output. Additionally, resonant reset inductor LL continues to reset until its current is zero and diode DL2 and DL1 turns off.

FIG. 3E illustrates the final switching stage before the cycle repeats. There is still no current flow on the primary side, and both leakage energy steering circuit CL, DL1 and resonant reset circuit LL, DL2 have completely reset. Thus, the only current flowing is secondary current 310, which is the regular discharge current delivering energy stored in transformer TX to the output. In this switching stage, the current flows are the same as in a conventional flyback converter. Once the energy stored in transformer TX is completely transferred to the output, the switching cycle can resume, returning to the switching stage illustrated above with respect to FIG. 3A.

FIG. 4 illustrates pertinent waveforms around the transition initiated at the end of the on period and the beginning of the reset period for a conventional flyback converter as shown in FIG. 1 (upper plot 400) and a flyback converter with a leakage energy steering circuit as shown in FIGS. 2 and 3A-3E (lower plot 410). In each plot, MSG is gate drive signal of main switch MS. Gate drive signal MSG transitions from high (i.e., main switch MS on) in the 407/417 regions, to low (i.e., main switch MS off) in the 408/418 regions. In each plot, MSD is the drain voltage of the main switch (i.e., the voltage across main switch MS and the voltage at the downstream end of primary winding Lp. Also, in each plot, ILp is the current flowing in primary winding Lp (i.e., the primary current), and ILs is the current flowing in secondary winding Ls (i.e., the secondary current). The plots assume the same operating conditions for each converter.

With reference to plot 400, conventional flyback converter 100 shows zero voltage 401 in the region where main switch MS is turned on. When main switch MS turns off, a noisy drain voltage 406 appears across the switch (and also across primary winding Lp), with a large voltage peak and multiple rings even with the presence of the clamping typical circuitry. Primary current ILp can be seen ramping up during the on time (401) and dropping during the off time, with significant ringing 402. Additionally, there can be seen a significant delay in the rising of secondary current ILs, which transitions from its near zero value 403 to a strongly ringing high value 404. In addition to being a noisy transition, this also generates significant power loss.

Turning to plot 410, flyback converter 200 with the leakage energy steering circuit discussed above shows a reduced MSD peak voltage 416, with its ringing eliminated or greatly reduced. At the same time secondary current ILs rises much faster (from 413 to 414) and also lacks the oscillations seen above. Additionally, the ringing of primary current ILp is significantly reduced (412.) Thus, it can be seen that steering the leakage energy Lke to secondary winding Ls can provide the benefits of reduced losses, reduced noise, and reduced voltage stress in the transition between charging and discharging modes of the flyback converter.

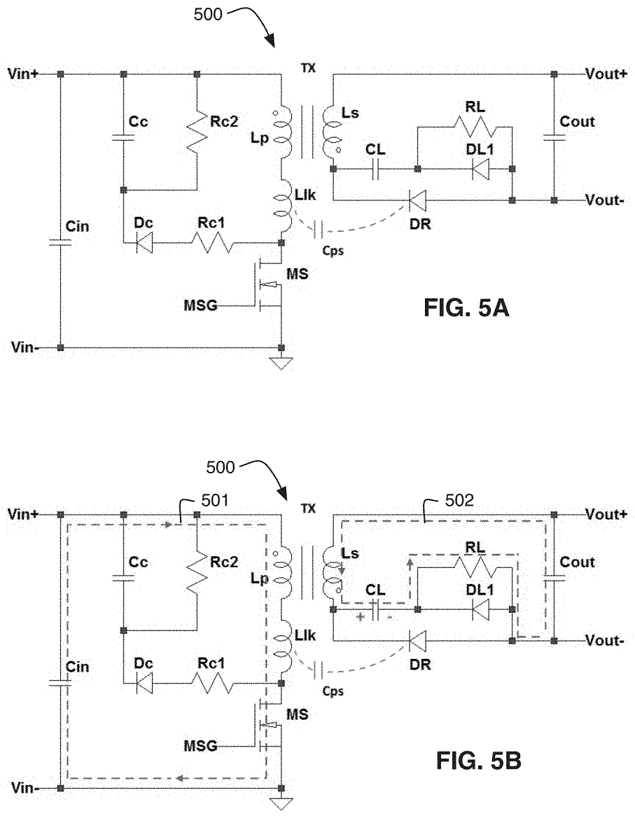

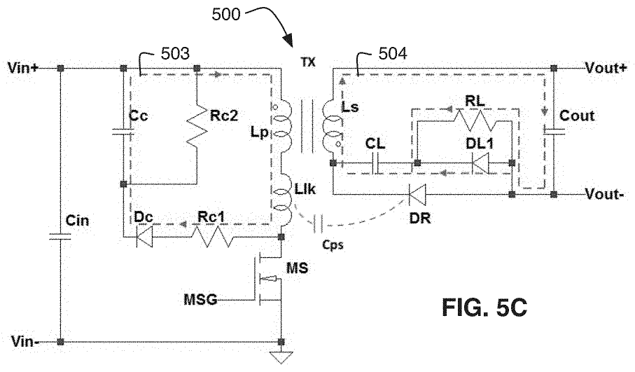

FIG. 5 illustrates a flyback converter including an alternative leakage energy steering circuit. More specifically, the leakage energy circuit may be simplified to include a resistor RL in parallel with leakage energy steering diode DL1. This resistor may, in some embodiments, replace the reset circuit discussed above. Resistor RL provides a path for capacitor CL to charge during turn on of the primary switch (MS) in an operation similar to that discussed above with respect to FIG. 3A and discussed in greater detail below with respect to FIG. 5B. During the beginning of the transformer reset phase, when current from the primary switch MS is diverted through the clamp, leakage energy steering capacitor CL may discharge into the output through DL1 in an operation similar to that discussed above with respect to FIG. 3C and discussed in greater detail below with respect to FIG. 5C.

FIG. 5B illustrates the beginning of the switching cycle. Main switch MS is turned on, and transformer TX begins to energize as primary current 501 flows through primary winding Lp from the input. At the same time, a voltage is induced across secondary winding Ls. The induced voltage causes a secondary current 502 that begins charging the leakage energy steering capacitor CL. Secondary current 502 flows through resistor RL and capacitor Cout back to the secondary winding.

FIG. 5C illustrates the other half of the switching sequence. In this stage, transformer TX is fully energized, so main switch MS is turned off, which stops the storing of energy in transformer TX. Primary current 503 begins circulating through the clamp circuitry. Primary winding Lp is thus decreasing towards a polarity reversal. As a result, the voltage across secondary winding Ls also tends to reverse polarity because of the polarity swap of primary winding Lp. Additonally, in the illustrated circuit, the voltage across leakage energy steering capacitor CL (resulting from the energy stored therein during the charging phase discussed above) causes secondary current 504. Secondary current 504 passes through resistor RL and also causes turn on of diode, DL. This provides a path for the charged leakage energy steering capacitor CL to discharge into the output thereby improving the overall efficiency of the circuit. This is an alternative embodiment of the leakage energy steering effect discussed above. Additionally, some of the leakage energy is circulated through the primary clamp circuitry (Rc1, Dc, Cc, and Rc2) by current 303 as shown.

In some embodiments, the efficiency improvement associated with the simplified leakage energy steering circuit of FIGS. 5A-5C (including a resistive path) may not be as great as would be achieved through use of the resonant reset circuit embodiment described above with respect to FIGS. 2-4. This smaller efficiency improvement may be attributed to the presence of the lossy resistive component RL that allows energy recovery only during the turn off phase of main switch MS. Nonetheless, this simplified embodiment may nonetheless be preferable in some embodiments because of reduced cost and reduced space requirements associated with eliminating the extra inductor.

Described above are various features and embodiments relating to leakage energy steering circuits for flyback converters. Such converters may be used in a variety of applications, but may be particularly advantageous when used for universal AC/DC converters (e.g., chargers) for personal electronic devices and the like.

Additionally, although numerous specific features and various embodiments have been described, it is to be understood that, unless otherwise noted as being mutually exclusive, the various features and embodiments may be combined in any of the various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. A flyback converter comprising:
a primary side comprising a primary winding configured to be coupled to input voltage terminals by a primary switching device;
a secondary side comprising a secondary winding magnetically coupled to the primary winding and configured to be coupled to output voltage terminals by a rectifying device;
wherein the primary switching device is operated alternately to store energy in the primary winding when closed and cause the stored energy to be transferred to the output voltage terminals when opened;
the flyback converter further comprising:
a leakage energy steering circuit comprising a steering circuit having a leakage energy steering capacitor and a leakage energy steering diode coupled to the secondary winding across the rectifying device and a reset circuit comprising an impedance element coupled to the leakage energy steering capacitor.

2. The flyback converter of claim 1 wherein the rectifying device is a diode.

3. The flyback converter of claim 1 wherein the rectifying device is a synchronous rectifier.

4. (canceled)

5. (canceled)

6. The flyback converter of claim 1 wherein the reset circuit comprises the impedance element and a diode coupling the leakage energy steering circuit to an output voltage terminal.

7. The flyback converter of claim 6 wherein the impedance element is an inductor.

8. The flyback converter of claim 6 wherein the impedance element is a resistor.

9. The flyback converter of claim 1 wherein the impedance element is a resistor in parallel with the leakage energy steering diode.

10. The flyback converter of claim 1 further comprising a clamp circuit on the primary side.

11. The flyback converter of claim 10 wherein the clamp circuit is a passive clamp circuit.

12. The flyback converter of claim 10 wherein the clamp circuit is an active clamp circuit.

13. A leakage energy steering circuit for a flyback converter, the leakage energy steering circuit comprising:
a leakage energy steering capacitor and a leakage energy steering diode configured to be coupled between a first output terminal and a first secondary winding terminal of the flyback converter; and
a reset circuit comprising an impedance element coupled between the leakage energy steering capacitor and an output terminal of the flyback converter.

14. The leakage energy steering circuit of claim 13 wherein the reset circuit comprises:
the impedance element and a diode configured to be coupled between a junction of the leakage energy steering capacitor and the leakage energy steering diode and a junction of a second secondary winding terminal and a second output terminal of the flyback converter.

15. The leakage energy steering circuit of claim 14 wherein the impedance element is an inductor.

16. The leakage energy steering circuit of claim 14 wherein the impedance element is a resistor.

17. The leakage energy steering circuit of claim 13 further wherein the impedance element is a resistor coupled in parallel with the leakage energy steering diode.

18. A flyback converter comprising:
a primary side, the primary side further comprising:
a primary winding coupled to a first input voltage terminal;
a main switching device coupled between to the primary winding and a second input voltage terminal; and
a clamp circuit coupled between a junction of the primary winding and the main switching device and one of the input terminals;
a secondary side, the secondary side further comprising:
a secondary winding magnetically coupled to the primary winding and coupled to a first output voltage terminal;
a rectifier device coupled between the secondary winding and a second output terminal; and
a leakage energy steering circuit comprising a steering circuit having a leakage energy steering capacitor and a leakage energy steering diode coupled to the secondary winding and one of the output terminals and a reset circuit comprising an impedance element coupled to the leakage energy steering capacitor;
wherein the main switching device is operated alternately to store energy in the primary winding when closed and cause the stored energy to be transferred to the output when opened.

19. The flyback converter of claim 18 wherein:
the leakage energy steering capacitor is coupled in series with the leakage energy steering diode; and
the impedance element and a diode are coupled between a junction of the leakage energy steering capacitor and the leakage energy steering diode and an output terminal of the flyback converter.

20. The flyback converter of claim 19 wherein the impedance element is an inductor.

21. The flyback converter of claim 19 wherein the impedance element is a resistor.

22. The flyback converter of claim 18 wherein the clamp circuit is a passive clamp circuit.

23. The flyback converter of claim 18 wherein:
the leakage energy steering capacitor is coupled in series with the leakage energy steering diode; and
the impedance element is a resistor coupled in parallel with the leakage energy steering diode.
